(19) United States
(12) Patent Application Publication
(10) Pub. No.: US 2026/0183886 A1
(43) Pub. Date: Jul. 2, 2026

(54) TOOL DIAGNOSIS SYSTEM, TOOL DIAGNOSIS DEVICE, AND TOOL DIAGNOSIS METHOD

(71) Applicant: Mitsubishi Electric Corporation, Chiyoda-ku, Tokyo (JP)

(72) Inventors: Tomokazu SAKAMOTO, Chiyoda-ku, Tokyo (JP); Ryosuke HARADA, Chiyoda-ku, Tokyo (JP)

(73) Assignee: Mitsubishi Electric Corporation, Chiyoda-ku, Tokyo (JP)

(21) Appl. No.: 18/865,910

(22) PCT Filed: May 23, 2023
(86) PCT No.: PCT/JP2023/019070

§ 371 Date: Nov. 14, 2024

(30) Foreign Application Priority Data
May 24, 2022 (JP) 2022-084248

(51) Int. Cl. B23Q 17/09; G05B 19/4065; G06T 7/00

(52) U.S. Cl. CPC B23Q 17/0995; G05B 19/4065; G06T 7/001; G06T 2207/30164

(57) ABSTRACT

A tool diagnosis system includes a machining device to machine a workpiece, an imaging device to capture an image of a blade of a tool attached to the machining device, an image processor to process an image of the blade, a model generator to generate a trained model through machine learning to learn a remaining service life of the tool using, as training data, a processed image of the blade, a machining condition, and specifications of the tool and the workpiece, and an inferrer to input a processed image of the blade, a machining condition, and specifications of the tool and the workpiece into the trained model to output the remaining service life. The image processor compares an image of the blade captured subsequent to machining with an image of the blade captured after the tool is rotated after the image capturing subsequent to machining, and identifies a wear scar.

### TECHNICAL FIELD

The present disclosure relates to a tool diagnosis system, a tool diagnosis device, a tool diagnosis method, and a program.

### BACKGROUND ART

A known tool diagnosis device generates a trained model through machine learning using images of a tool blade, machining conditions, and specification data for the tool and a workpiece, and inputs an image of a new tool blade, machining conditions, and specification data for the tool and the workpiece into the trained model to acquire an output that predicts wear of the tool (Patent Literature 1).

### CITATION LIST

### Patent Literature

Patent Literature 1: Unexamined Japanese Patent Application Publication No. 2021-70114

### SUMMARY OF INVENTION

### Technical Problem

However, with such a tool diagnosis device, any foreign objects other than patterns resulting from wear, such as chips or a cutting fluid, on an image of a tool blade may be erroneously recognized as patterns of wear, lowering the prediction accuracy of the trained model. Although such foreign objects may be removed manually, machine learning uses tens to hundreds of images. Manually removing foreign objects is thus time-consuming and impractical.

Under such circumstances, an objective of the present disclosure is to generate a trained model with sufficient prediction accuracy without being time-consuming in tool diagnosis.

### Solution to Problem

To achieve the above objective, a tool diagnosis system according to an aspect of the present disclosure includes a machining device to machine a workpiece, an imaging device to capture an image of a blade of a tool attached to the machining device, an image processor to process an image of the blade of the tool, a model generator to generate a trained model through machine learning to learn a remaining service life using, as training data, a processed image of the blade of the tool, a machining condition of the machining device, and specifications of the tool and the workpiece, and an inferrer to input a processed image of the blade of the tool, a machining condition of the machining device, and specifications of the tool and the workpiece into the trained model to output the remaining service life. The image processor compares an image of the blade of the tool captured subsequent to machining with an image of the blade of the tool captured after the tool is rotated at high speed after the image capturing subsequent to machining, and identifies a wear scar.

### Advantageous Effects of Invention

The technique according to the above aspect of the present disclosure allows generation of a trained model with sufficient prediction accuracy without being time-consuming in tool diagnosis simply by rotating the tool at high speed and identifying a tool wear scar using images of the tool captured before and after the rotation.

### BRIEF DESCRIPTION OF DRAWINGS

FIG. 1 is a block diagram of a tool diagnosis system according to Embodiment 1 of the present disclosure;

FIG. 2 is a block diagram of a tool diagnosis device according to Embodiment 1 of the present disclosure;

FIG. 3A is a diagram illustrating a process of cutting a workpiece with a blade of a tool;

FIG. 3B is a diagram illustrating wear of the tool blade in the process of cutting the workpiece with the tool blade;

FIG. 4 is a graph illustrating the relationship between the size of a wear scar and the remaining service life in Embodiment 1 of the present disclosure;

FIG. 5A is a view of the tool after machining as viewed in the rotation axis direction of the tool;

FIG. 5B is a view of the tool after high-speed rotation performed in the state in FIG. 5A as viewed in the rotation axis direction of the tool;

FIG. 6 is a flowchart of an operation for an imaging process in Embodiment 1 of the present disclosure;

FIG. 7 is a flowchart of an image processing operation in Embodiment 1 of the present disclosure;

FIG. 8 is a block diagram of a learner in Embodiment 1 of the present disclosure;

FIG. 9 is a diagram of a neural network in Embodiment 1 of the present disclosure;

FIG. 10 is a flowchart of an operation for a learning process in Embodiment 1 of the present disclosure;

FIG. 11 is a block diagram of an inferrer in Embodiment 1 of the present disclosure;

FIG. 12 is a flowchart of an operation for a tool replacement determination process in Embodiment 1 of the present disclosure;

FIG. 13 is a diagram of the tool diagnosis device according to Embodiment 1 of the present disclosure, illustrating the hardware configuration;

FIG. 14 is a block diagram of a tool diagnosis system according to Embodiment 2 of the present disclosure;

FIG. 15 is a block diagram of a tool diagnosis system according to Embodiment 3 of the present disclosure;

FIG. 16 is a block diagram of a tool diagnosis system according to Embodiment 4 of the present disclosure;

FIG. 17A is a view of a tool after machining in Embodiment 5 of the present disclosure as viewed in a direction perpendicular to the rotation axis direction of the tool;

FIG. 17B is a view of the tool after machining in Embodiment 5 of the present disclosure as viewed in the rotation axis direction of the tool;

FIG. 18A is a view of the tool after high-speed rotation in Embodiment 5 of the present disclosure as viewed in the direction perpendicular to the rotation axis direction of the tool;

FIG. 18B is a view of the tool after high-speed rotation in Embodiment 5 of the present disclosure as viewed in the rotation axis direction of the tool; and

FIG. 19 is a block diagram of a tool diagnosis system according to Embodiment 5 of the present disclosure.

### DESCRIPTION OF EMBODIMENTS

A tool diagnosis system 100 according to one or more embodiments of the present disclosure is described with reference to the drawings, Like reference signs denote like or corresponding components in the drawings.

### Embodiment 1

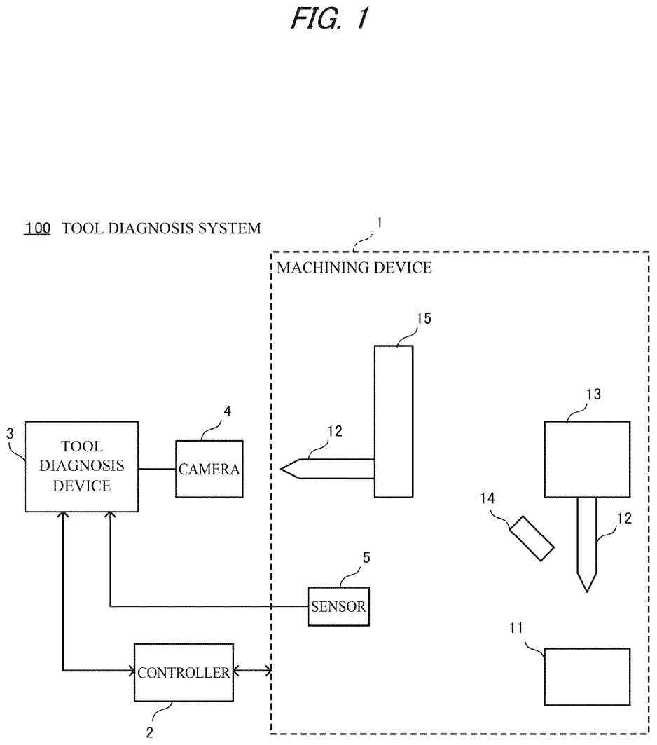

FIG. 1 is a block diagram of the tool diagnosis system 100 according to Embodiment 1 of the present disclosure, The tool diagnosis system 100 includes a machining device 1 for cutting a target object, a controller 2 connected to the machining device 1 to control an operation of the machining device, a tool diagnosis device 3 for diagnosing the wear state of a tool used in the machining device 1, a camera 4 connected to the tool diagnosis device 3 to serve as an imaging device for capturing an image of the tool, and a sensor 5 connected to the tool diagnosis device 3 to detect the state of the machining device 1 during machining.

The machining device 1 includes a tool 12 for cutting a workpiece 11 as the target object, a main spindle motor 13 that rotates the tool 12, a cutting fluid outlet 14 for spraying a cutting fluid onto the tool 12 during machining, and an automatic tool changer 15 that automatically replaces the tool 12. The tool 12 is used for machining, such as milling and drilling, and is attached securely to the main spindle motor 13 in a removable manner. The tool 12 rotates as the main spindle motor 13 is driven to rotate. While the main spindle motor 13 is rotating, the tool 12 is moved toward and comes in contact with the workpiece 11 to cut and machine the workpiece 11 into an intended shape. The tool 12 generates heat from friction with the workpiece 11. The cutting fluid outlet 14 for spraying the cutting fluid onto the tool 12 to cool the tool 12 is thus located near the tool 12. During cutting, the cutting fluid is sprayed onto the tool 12 through the cutting fluid outlet 14 to cool the tool 12 that has generated heat from friction. The automatic tool changer 15 automatically replaces tools in machining. The automatic tool changer 15 includes a tool magazine containing multiple tools, and replaces the tool 12 attached to the main spindle motor 13 with a tool contained in the tool magazine. The tools are automatically replaced by selecting a tool 12 to be used next from multiple tools in the tool magazine based on a tool replacement instruction in a machining program executed by the controller 2 in the machining device 1, rotating and moving the tool magazine to a position near the main spindle for replacement, and replacing the tool 12 attached to the main spindle with the selected tool 12.

The camera 4 is installed outside the machining device 1 at a position to capture an image of the blade of the tool 12 fixed to the automatic tool changer 15 for replacement. The camera 4 is, for example, a complementary meta-oxide semiconductor (CMOS) camera, a charge-coupled device (CCD) camera, a hyperspectral camera, or a time-of-flight (TOF) camera. The camera 4 is connected to the tool diagnosis device 3 with a communication cable. The image captured by the camera 4 undergo analog-digital (A/D) conversion before being transmitted to the tool diagnosis device 3.

The machining device 1 incorporates the sensor 5. The sensor 5 is, for example, an acceleration sensor, a current detection sensor, or a voltage detection sensor located in the main spindle motor 13, or a pressure sensor or a temperature sensor located at the cutting fluid outlet 14 to detect machining state data including motor specification data during machining (for example, motor speed, motor torque, acceleration waveform, current waveform, and voltage waveform) and information associated with machining (for example, cutting fluid outlet pressure and cutting fluid temperature). The sensor 5 is connected to the tool diagnosis device 3 with a communication cable. The machining state data detected by the sensor S is transmitted to the tool diagnosis device 3.

The controller 2 is a numerical controller that controls the machining device 1. For example, the controller 2 controls the machining device 1 for cutting the workpiece 11 by setting, in a prestored machining program, the machining conditions such as the rotational speed of the main spindle, the feeding speed, and the cut amount, the type and the material of the tool 12 to be used, and the specifications of the tool 12 and the workpiece 11 such as the material of the workpiece 11. The controller 2 also transmits the set machining conditions of the machining device 1 and the specification data for the tool 12 and the workpiece 11 to the tool diagnosis device 3.

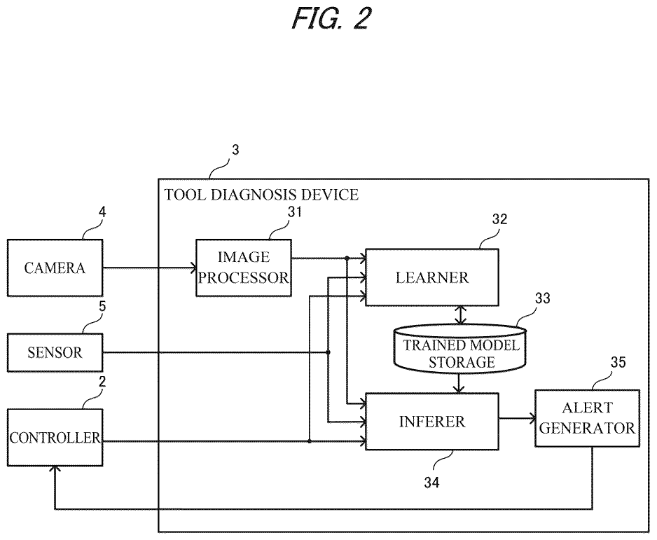

As illustrated in FIG. 2, the tool diagnosis device 3 includes an image processor 31 that processes image data captured by the camera 4, a learner 32 that receives input of image data processed by the image processor 31, machining conditions of the machining device 1 and specification data for the tool 12 and the workpiece 11 transmitted from the controller 2, and machining state detection data detected by the sensor 5, and learns the remaining service life of the tool 12 before the use limit due to wear, a trained model storage 33 that stores a trained model generated through such learning, an inferrer 34 that receives, similarly to the learner 32, input of image data processed by the image processor 31, machining conditions of the machining device 1 and specification data for the tool 12 and the workpiece 11 transmitted from the controller 2, and machining state detection data detected by the sensor 5, and infers the remaining service life of the tool 12 using the trained model stored in the trained model storage 33, and an alert generator 35 that generates an alert to replace the tool 12 based on the inferred remaining service life of the tool 12. The image processor 31 processes the image data about the blade of the tool 12 captured by the camera 4 to extract color areas discolored by wear, and performs edge detection of the labeled color areas to extract the profile of the wear scar and acquire edge information for the wear sear. The wear scar is larger as the tool wear increases. The remaining service life of the tool 12 can thus be determined by measuring the size of the wear scar and allows determination as to whether the tool is to be replaced based on the determined remaining service life.

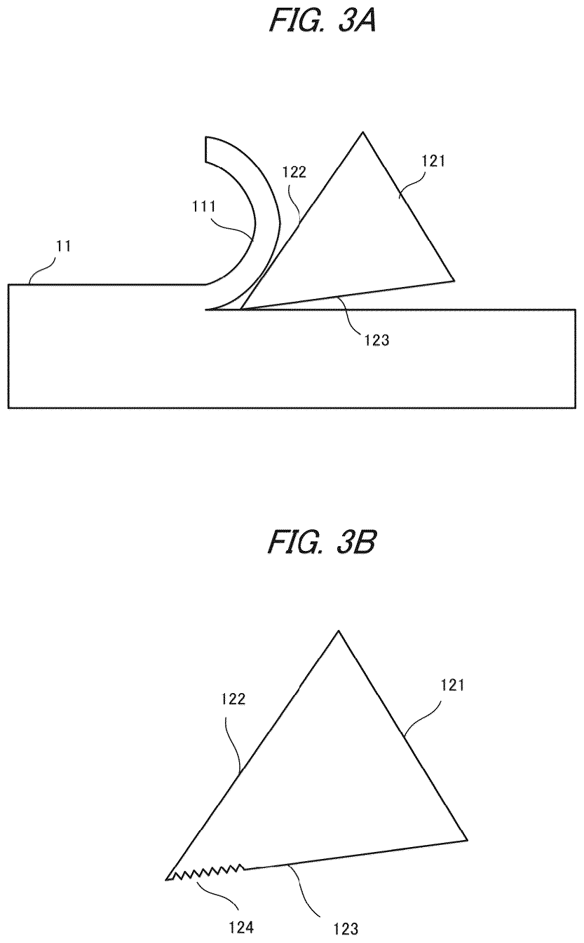

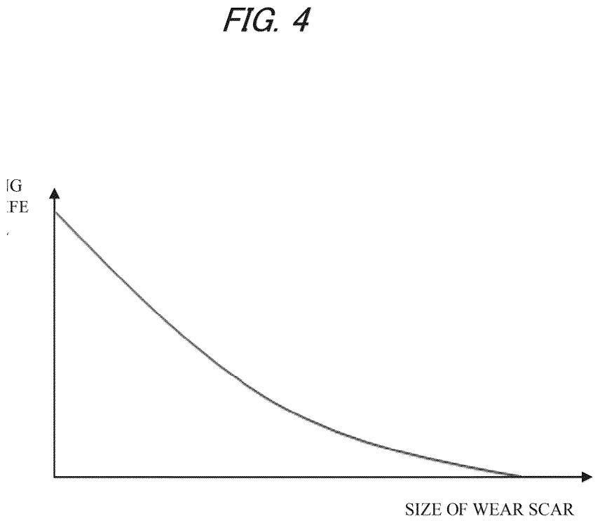

FIG. 3A is a schematic diagram illustrating a process of cutting the workpiece 11 with a blade 121 of the tool 12. A chip 111 is generated when the workpiece 11 is cut with the blade 121 of the tool 12. FIG. 3B is a schematic diagram illustrating wear of the blade 121 of the tool 12 in FIG. 3A in the process of cutting the workpiece 11 with the blade 121 of the tool 12. The blade 121 of the tool 12 includes a rake face 122 and a flank face 123. As the blade 121 cuts the workpiece 11, the chip 111 slides on the flank face 123. A wear scar 124 thus forms on the flank face 123 from friction with the chip 111. The wear scar 124 is larger in proportion to the number of machining cycles and the machining distance for the tool 12. When the wear scar 124 reaches a certain size, more resistance occurs in cutting the workpiece 11 and increases the roughness of the machining surface of the workpiece 11. When the tool 12 is a drill, the wear scar 124 on the drill blade may reach a certain size that increases the resistance in forming a hole in the workpiece 11 and may increase the diameter of the hole to more than the diameter designed. In the above stage, that tool 12 is determined to have reached the end of the service life and is replaced. The service life refers to the number of machining cycles and the machining distance to be used by the tool 12 in a new state before the use limit, or the durable number of machining cycles and the machining distance before the use limit. The remaining service life refers to the number of machining cycles and the machining distance to be used by the tool 12 in the current state before the use limit, or the durable number of machining cycles and the machining distance before the use limit. When the wear scar 124 on the blade 121 of the tool 12 reaches a certain size, the tool 12 can be determined to have reached the end of life. Thus, the usability of the tool 12 can be determined by observing the size of the wear scar 124 on the blade 121 of the tool. FIG. 4 illustrates an example relationship between the size of the wear sear 124 and the remaining service life of the tool 12. The vertical axis indicates the remaining service life, and the horizontal axis indicates the size of the wear scar 124. In FIG. 4, as the size of the wear scar 124 increases, the remaining service life decreases rapidly. When the relationship between the size of the wear scar 124 and the remaining service life of the tool 12 is known as illustrated in FIG. 4, the remaining service life of the tool 12 can be calculated based on the wear scar 124 to determine whether the tool 12 is to be replaced.

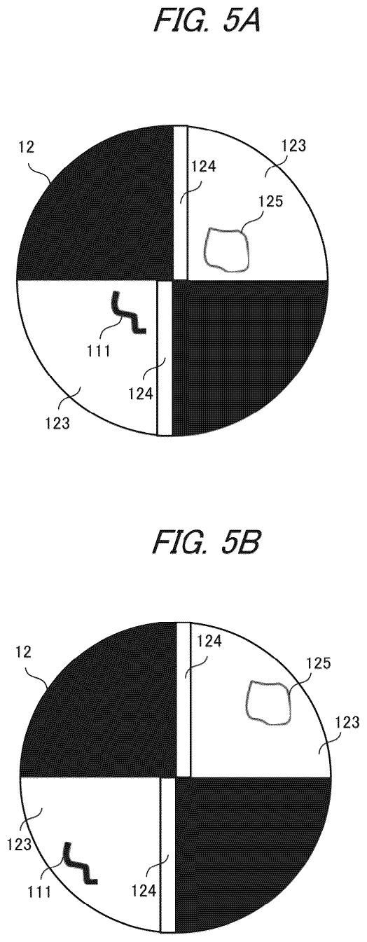

To accurately calculate the remaining service life of the tool 12, the wear scar 124 is to be detected correctly. However, the chip 111 during machining and the cutting fluid to cool the tool can cause incorrect detection of the wear scar 124. FIG. 5A is a view of the tool 12 after machining as viewed in the rotation axis direction of the tool. After machining, the flank face 123 of the blade 121 of the tool has the cutting fluid 125 and the chip 111 adhering to the flank face 123. The image captured by the camera 4 is two-dimensional data with no data in the depth direction. Thus, the pattern in the image cannot be determined to be the wear scar 124 or the cutting fluid 125 and the chip 111, The cutting fluid 125 and the chip 111 may thus be measured as the wear scar 124. In this case, the size of the wear scar 124 on the blade 121 of the tool can differ from the actual size. When the remaining service life of the tool 12 is calculated using this data, the determination as to whether the tool 12 is to be replaced cannot be performed correctly, When the tool 12 reaches the service life during machining, the workpiece 11 may be processed inappropriately and may be defective.

To prevent the cutting fluid 125 and the chip 111 from being erroneously recognized as the wear scar 124, the tool 12 is rotated at high speed after machining to remove, using a centrifugal force, the cutting fluid 125 and the chip 111 adhering to the tool 12 from the flank face 123. The camera 4 can capture an image of the tool 12 after the high-speed rotation to provide the image of the tool 12 from which the cutting fluid 125 and the chip 111 have been removed. This reduces the likelihood that the cutting fluid 125 and the chip 111 are erroneously recognized as the wear scar 124.

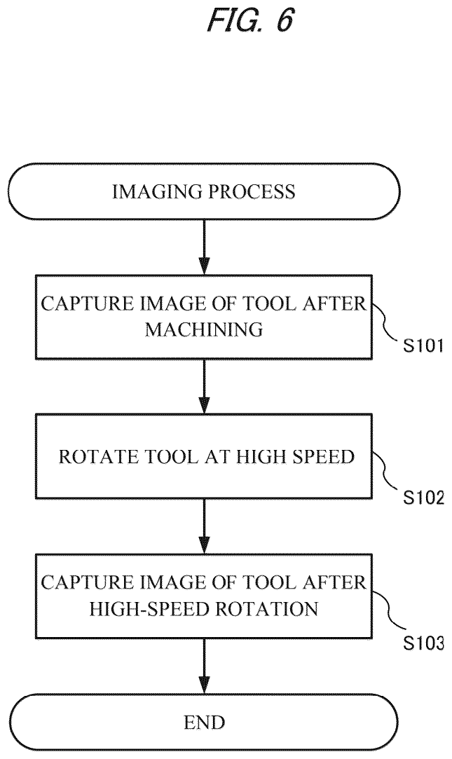

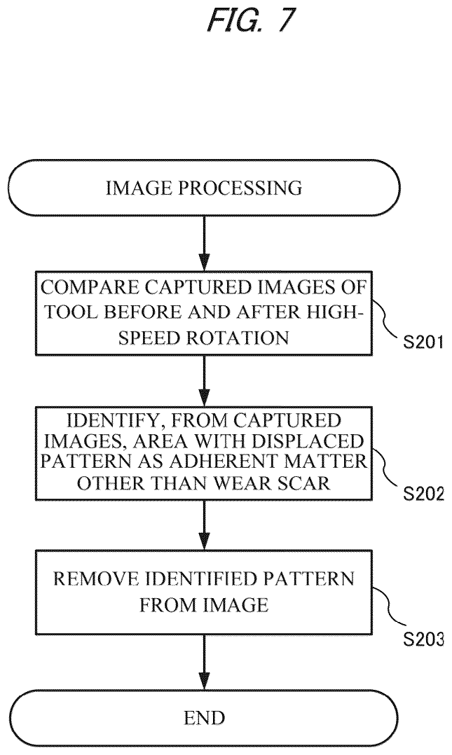

However, the cutting fluid 125 and the chip 111 may not be removed through such high-speed rotation. This is described below. FIG. 5B is a view of the tool 12 after high-speed rotation performed in the state in FIG. 5A as viewed in the rotation axis direction of the tool 12. When the tool 12 rotates at high speed, the cutting fluid 125 and the chip 111 adhering to the tool 12 are not removed completely, but move away from the rotation center. More specifically, the cutting fluid 125 and the chip 111 are at different positions before and after the high-speed rotation of the tool 12. In contrast, the wear scar 124 remains at the same position before and after the high-speed rotation of the tool 12. Thus, the images of the tool 12 are to be captured before and after the high-speed rotation of the tool 12 for comparison to identify any patterns displaced away from the rotation center as the cutting fluid 125 and the chip 111. FIG. 6 is a flowchart of an operation for a process of imaging the tool 12 with the camera 4 before and after the high-speed rotation. After machining, the controller 2 moves the tool 12 to a position at which the camera 4 can capture an image of the tool 12 fixed to the automatic tool changer 15, and causes the camera 4 to capture an image of the blade 121 of the tool 12 (step S101). After the imaging, the controller 2 attaches the tool 12 to the main spindle motor 13 and rotates the tool 12 at high speed (step S102). After the high-speed rotation, the controller 2 moves the tool 12 to a position at which the camera 4 can capture an image, and causes the camera 4 to again capture an image of the blade 121 of the tool 12 (step S103). When the processing in step S103 is performed, the imaging process ends. The tool 12 may be rotated at high speed and then be imaged by the camera 4 once or multiple times. The rotational speed may be changed every rotation time, or may be changed during rotation. After the imaging process, the captured images are transmitted to the tool diagnosis device 3. The tool diagnosis device 3 processes the transmitted images with the image processor 31. FIG. 7 illustrates an image processing operation performed by the image processor 31. The image processor 31 compares the transmitted images before and after the high-speed rotation to determine whether any pattern has been displaced (step S201). When the comparison detects a displaced pattern, the pattern area is identified as being the cutting fluid 125 or the chip 111 that is adherent matter other than the wear sear 124 and moved by the high-speed rotation (step S202). When the cutting fluid 125 and the chip 111 are identified, image processing is performed to remove the identified pattern from the image (step S203), and the image processing ends. This allows the wear scar 124 alone to be extracted from the image and allows the size of the wear scar 124 alone to be measured from the image of the blade 121 of the tool 12. Although the above image processing is performed by the image processor 31, the image processing may be performed by the camera 4.

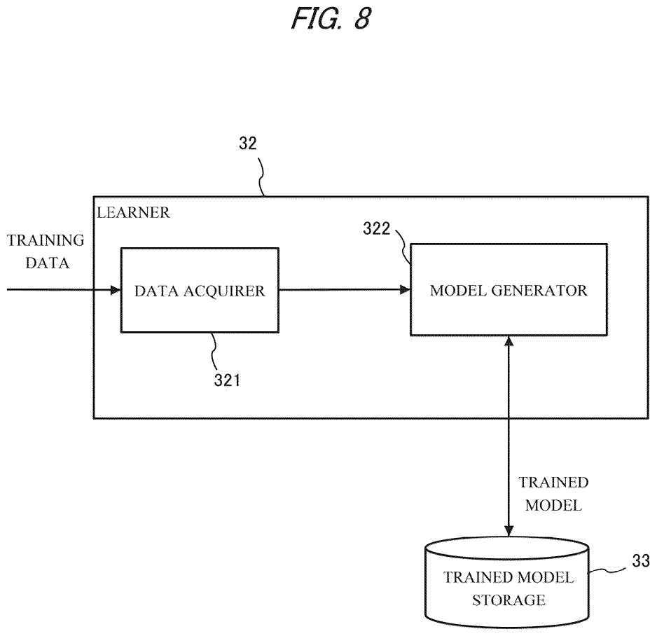

As described above, the tool diagnosis device 3 includes the learner 32 that learns the remaining service life of the tool 12 before the use limit due to wear using the image data processed as described above as one input, and the inferrer 34 that infers the remaining service life of the tool 12 using the trained model. As illustrated in FIG. 8, the learner 32 includes a data acquirer 321 that acquires training data including image data about the blade 121 of the tool 12 transmitted from the camera 4, machining conditions of the machining device 1 transmitted from the controller 2, specification data for the tool and the workpiece, and the machining state detection data detected by the sensor 5, and a model generator 322 that generates the trained model through machine learning using the training data acquired by the data acquirer 321 as input data. The trained model generated by the model generator 322 is stored in a trained model storage 33, The remaining service life of the tool 12 is learned using training data including image data about the blade 121 of the tool 12 captured by the camera 4, machining state detection data about the machining device acquired by the data acquirer 321, specification data for the tool 12 and the workpiece 11, and machining state detection data. More specifically, the trained model for interring the remaining service life of the tool 12 is generated based on image data about the blade 121 of the tool 12, machining state detection data about the machining device 1, specification data for the tool 12 and the workpiece 11, and machining state detection data. The training data includes image data about the blade 121 of the tool, machining state detection data about the machining device 1, specification data for the tool 12 and the workpiece 11, machining state detection data, and data about the remaining service life of the tool 12 associated with each other.

Although the learner 32 and the inferrer 34 are used to learn the remaining service life of the tool 12 in the machining device 1, the learner 32 and the inferrer 34 may be, for example, a training device or an inference device separate from the machining device 1 and connected to the machining device 1 through a network. The learning device and the inference device may be incorporated in the machining device 1 or the controller 2. The learning device and the inference device may be located in a cloud server.

The model generator 322 may use a known learning algorithm such as supervised learning, unsupervised learning, or reinforcement learning. In the example described below, a neural network is used. The model generator 322 learns the durable number of machining cycles and the machining distance before the use limit of the tool 12 through supervised learning based on, for example, a neural network model. Supervised learning refers to providing, to the learner 32, a set of input data and resultant data (labels), learning features of the training data, and inferring a result from the input data.

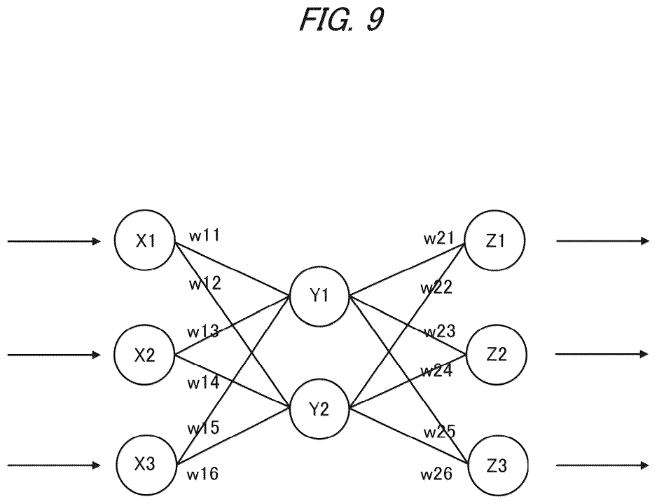

The neural network includes an input layer including multiple neurons, an intermediate layer (hidden layer) including multiple neurons, and an output layer including multiple neurons. The neural network may include a single intermediate layer or two or more intermediate layers. For example, a neural network with three layers as illustrated in FIG. 9 receives multiple inputs into the input layer (X1 to X3). The input values multiplied by weights W1 (w11 to w16) are input into the intermediate layer (Y1 to Y2). The resultant values are further multiplied by weights W2 (w21 to w26) and output from the output layer (Z1 to Z3). The output results vary with the values of the weights W1 and W2.

In the present embodiment, the neural network learns the remaining service life of the tool 12 through supervised learning using training data generated based on a combination of image data about the blade 121 of the tool 12, machining condition data about the machining device 1, specification data for the tool 12 and the workpiece 11, machining state data, and the remaining service life of the tool 12 acquired by the data acquirer 321. More specifically, the neural network learns by adjusting the weights W1 and W2 to cause the result that is output from the output layer based on input of the image data about the blade 121 of the tool 12, the machining condition data about the machining device 1, the specification data for the tool 12 and the workpiece 11, and the machining state data into the input layer to approach the remaining service life of the tool 12. The model generator 322 generates the trained model through the above learning. The resultant trained model is output to the trained model storage 33. The trained model storage 33 stores the trained model output from the model generator 322.

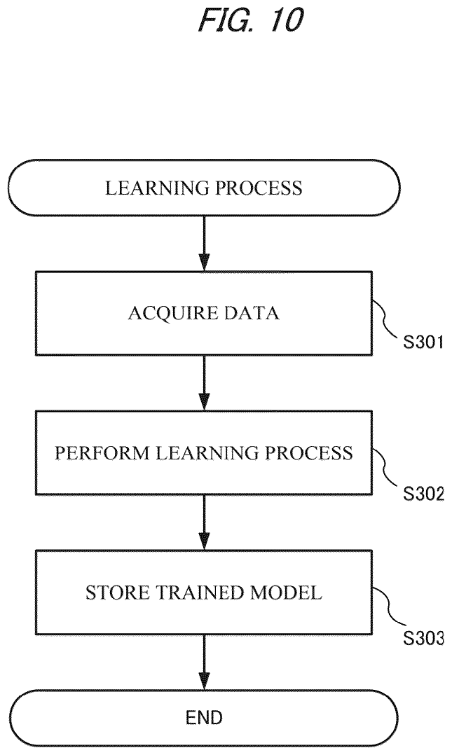

The learning process performed by the learner 32 is described with reference to FIG. 10. In step S301, the data acquirer 321 acquires image data about the blade 121 of the tool 12, the machining condition data of the machining device 1, the specification data for the tool 12 and the workpiece 11, the machining state data, and the remaining service life of the tool 12. Although the image data about the blade 121 of the tool 12 and the remaining service life of the tool 12 are simultaneously acquired, the image data about the blade 121 of the tool 12 and the remaining service life of the tool 12 may be input in any manner associated with each other. Thus, the image data about the blade 121 of the tool 12 and the remaining service life of the tool 12 may be acquired at different times. In step S302, the model generator 322 performs a learning process to generate a trained model by learning the remaining service life of the tool 12 through supervised learning using the training data generated based on a combination of the image data about the blade 121 of the tool 12, the machining condition data about the machining device 1, the specification data for the tool 12 and the workpiece 11, the machining condition data, and the remaining service life of the tool 12 acquired by the data acquirer 321. In step S303, the trained model storage 33 stores the trained model generated by the model generator 322. When step S303 is performed, the learning process ends.

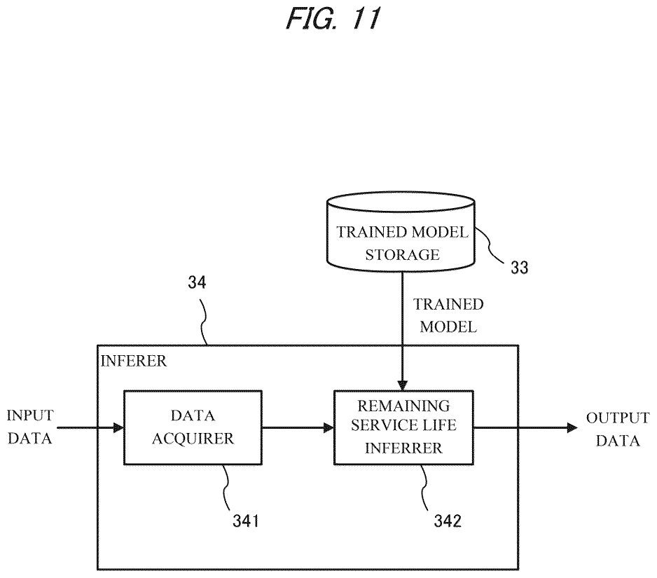

When the trained model is generated, the inferrer 34 uses the trained model to infer the remaining service life of the fool 12. As illustrated in FIG. 11, the inferrer 34 includes a data acquirer 341 and a remaining service life inferrer 342. The inferrer 34 reads the trained model from the trained model storage 33 and uses the trained model for inference. The data acquirer 341 acquires image data about the blade 121 of the tool 12, machining condition data about the machining device 1, specification data for the tool 12 and the workpiece 11, and machining state data. The remaining service life inferrer 342 infers the remaining service life of the tool 12 acquired using the trained model. More specifically, the image data about the blade 121 of the tool 12, the machining condition data about the machining device 1, the specification data for the tool 12 and the workpiece 11, and the machining state data acquired by the data acquirer 341 are input into the trained model to acquire an output of the remaining service life of the tool 12 inferred from the image data about the blade 121 of the tool 12, the machining condition data about the machining device 1, and the specification data for the tool 12 and the workpiece 11. In the present embodiment described above, the remaining tool service life of the tool 12 is output using the trained model trained by the model generator 322 in the learner 32 using input of data about the machining device 1. The remaining tool service life of the tool 12 may be output based on the trained model acquired externally from, for example, another machining device or another learning device.

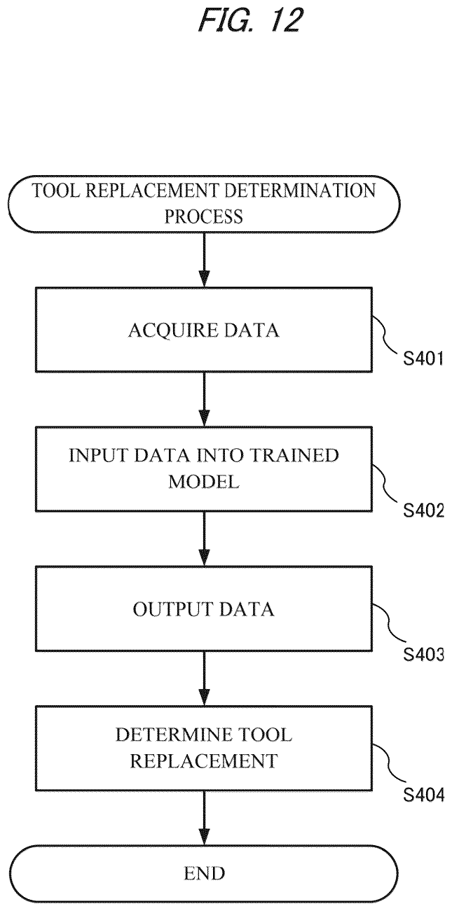

The operation for a tool replacement determination process performed by the inferrer 34 and the alert generator 35 is described with reference to FIG. 12. In step S401, the data acquirer 341 acquires image data about the blade 121 of the tool 12, machining condition data about the machining device 1, specification data for the tool 12 and the workpiece 11, and machining state data. To acquire image data about the blade 121 of the tool 12, images of the blade 121 of the tool 12 are captured subsequent to machining and after high-speed rotation with the camera 4, and the two images are compared to identify any patterns displaced away from the rotation center as the cutting fluid 125 and the chip 111. The identified cutting fluid 125 and the identified chip 111 are removed from the images through image processing performed by the image processor 31. The wear scar 124 alone is extracted from the images of the blade 121 of the tool 12, and the size of the wear scar 124 is measured. In step S402, the inferrer 34. inputs image data about the blade 121 of the tool 12, machining condition data about the machining device 1, specification data for the tool 12 and the workpiece 11, and machining state data into the trained model stored in the trained model storage 33, and acquires the remaining service life of the tool 12. In step S403, the inferrer 34 outputs the remaining service life of the tool 12 acquired using the trained model to the alert generator 35. In step S404, the alert generator 35 compares the output remaining service life of the tool 12 with the number of machining cycles and the machining distance for machining the workpiece 11. When the remaining service life of the tool 12 is shorter than a service life for the number of machining cycles and the machining distance for machining the workpiece 11, the alert generator 35 generates an alert to prompt the user to replace the tool 12. The alert may be visual or audible. The alert generator 35 also notifies the controller 2 that the remaining service life of the tool 12 is insufficient. Upon receiving the notification, the controller 2 may perform control for automatically replacing the tool 12. This maximizes the service life of the tool 12.

Although the learning algorithm used by the model generator 322 in the learner 32 is a supervised learning algorithm in the present embodiment, the embodiment is not limited to this example. The learning algorithm used may be an algorithm other than supervised learning and may be, for example, reinforcement learning, unsupervised learning, or semi-supervised learning. The model generator 322 may learn the durable number of machining cycles and the machining distance before the use limit of the tool 12 based on training data generated for multiple machining devices 1. The model generator 322 may acquire training data from multiple machining devices 1 used in the same area, or may use training data collected from multiple machining devices 1 operating independently of one another in different areas to learn the durable number of machining cycles and the machining distance before the use limit of the tool 12. A machining device 1 for collecting training data may be added or removed during the process. A learning device that has learned the durable number of machining cycles and the machining distance before the use limit of the tool 12 for a machining device 1 may be used for a different machining device 1, and the durable machining cycles and the machining distance before the use limit of the tool 12 for the different machining device 1 may be relearned and updated. The model generator 322 may use, as a learning algorithm, deep learning for learning extraction of features or may perform machine learning using other known methods such as genetic programming, functional logic programming, and a support vector machine.

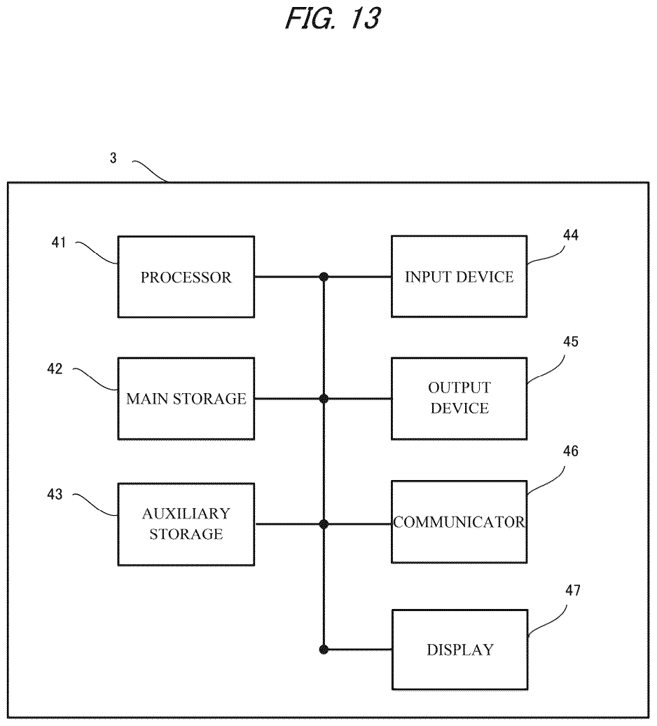

As illustrated in FIG. 13, the tool diagnosis device 3 is a computer. The tool diagnosis device 3 includes, as hardware components, a processor 41 that processes data based on a control program, a main storage 42 that serves as a work area for the processor, an auxiliary storage 43 that stores data over a long time, an input device 44 that receives data inputs, an output device 45 that outputs data, a communicator 46 that communicates with other devices, a display 47, and a bus connecting these components to one another. The auxiliary storage 43 stores a control program for the data collection process performed by the processor. The input device 44 receives image data transmitted from the camera 4, machining conditions and specification data for the tool 12 and the workpiece 11 transmitted from the controller 2, and machining state data transmitted from the sensor 5, and provides the data to the processor 41. The processor 41 functions as the image processor 31, the learner 32, the inferrer 34, and the alert generator 35 illustrated in FIG. 2 by reading the program stored in the auxiliary storage. 43 into the main storage 42 and then executing the program. The auxiliary storage 43 functions as the trained model storage 33.

### Embodiment 2

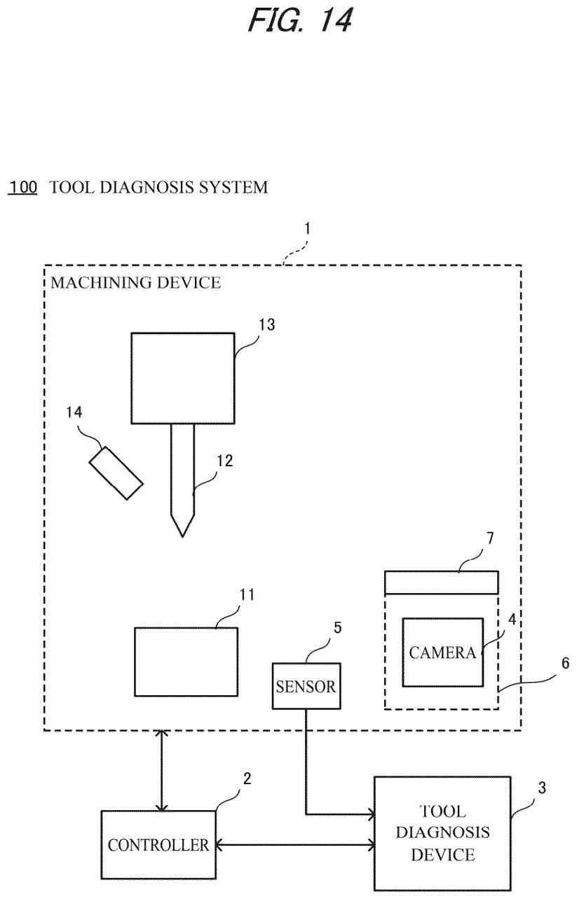

In Embodiment 1, the machining device 1 contains the automatic tool changer 15. The camera 4 is installed outside the machining device 1 to capture an image of the blade 121 of the tool 12 fixed to the automatic tool changer 15 for replacement. In contrast, Embodiment 2 describes the arrangement of the camera 4 when a machining device 1 with no automatic tool changer 15 is used. FIG. 14 is a block diagram of a tool diagnosis system 100 according to Embodiment 2 of the present disclosure, The machining device 1 does not include the automatic tool changer 15. Thus, the camera 4 for monitoring the blade 121 of the tool 12 is installed in the machining device 1 to directly capture an image of the tool 12 attached to the main spindle motor 13. To protect the camera 4 from the cutting fluid 125 and the chip 111, the camera 4 is installed in a camera protective cover 6 and a camera protective shutter 7. The camera protective cover 6 is a box surrounding the camera 4 excluding the upper surface. The camera protective cover 6 includes, on the upper surface, the camera protective shutter 7 that covers the lens of the camera 4 installed in the camera protective cover 6. The camera protective shutter 7 can be automatically opened and closed as controlled by the controller 2. The camera protective cover 6 is horizontally movable between a lower position facing the tool 12 attached to the main spindle motor 13 and a position not facing the tool 12. The camera protective cover 6 moves automatically as controlled by the controller 2.

When an image of the blade 121 of the tool 12 is captured, the spindle motor 13 and spraying of the cutting fluid 125 are stopped. The camera 4 protected by the camera protective cover 6 and the camera protective shutter 7 moves to a position directly under the tool 12 together with the camera protective cover 6 and the camera protective shutter 7. The camera protective shutter 7 is then open to capture an image of the blade 121 of the tool 12 with the camera 4 exposed. When the imaging ends, the camera protective shutter 7 is closed, and the camera protective cover 6 moves from the position directly under the tool 12, thus causing the camera 4 to retract from the position directly under the tool 12.

Although the camera 4 moves in the present embodiment, the camera 4 may be stationary and the tool 12 may move to the position of the camera 4. This structure allows the tool diagnosis system according to one or more embodiments of the present disclosure to be used for the machining device 1 incorporating no automatic tool changer 15. The structure also eliminates the work of transferring the tool 12 to the automatic tool changer 15, thus shortening the time for tool diagnosis.

### Embodiment 3

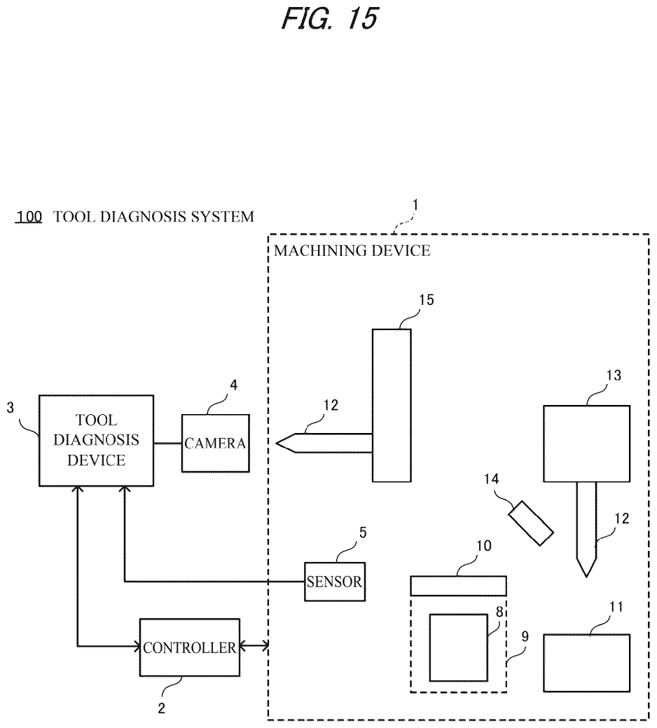

In Embodiment 1, the tool 12 is rotated at high speed after machining to remove or move the cutting fluid 125 and the chip 111 adhering to the blade 121. This allows the wear scar 124 to be correctly extracted without the cutting fluid 125 and the chip 111 being erroneously recognized as the wear scar 124. In Embodiment 3, the cutting fluid 125 and the chip 111 firmly adhering to the tool 12 and cannot be removed or moved by high-speed rotation of the tool 12 can be removed or moved. FIG. 15 is a block diagram of a tool diagnosis system 100 according to Embodiment 3, In the present embodiment, a machining device 1 contains an ultrasonic cleaner 8 for cleaning the tool 12. The ultrasonic cleaner 8 is installed in an ultrasonic cleaner protective cover 9 and an ultrasonic cleaner protective shutter 10, and is protected from the cutting fluid 125 and the chip 111. After machining and before the tool 12 is transferred to the automatic tool changer 15, the tool 12 is moved to a position directly above the ultrasonic cleaner 8, and the blade 121 of the tool 12 is immersed in a cleaning solution such as acetone or ethanol stored in the cleaning container of the ultrasonic cleaner 8 for ultrasonic cleaning. After the ultrasonic cleaning, the tool 12 is transferred to the automatic tool changer 15. The tool diagnosis device 3 then determines whether the tool 12 is to be replaced. This structure can remove the cutting fluid 125 and the chip 111 firmly adhering to the tool 12 and not displaced by the high-speed rotation of the tool 12 or reduce the degree of adherence of such a cutting fluid 125 and a chip 111 to the tool 12. The cutting fluid 125 and the chip 111 can be displaced by the high-speed rotation of the tool 12, thus removing the cutting fluid 125 and the chip 111 from the captured image more reliably than in Embodiment 1.

### Embodiment 4

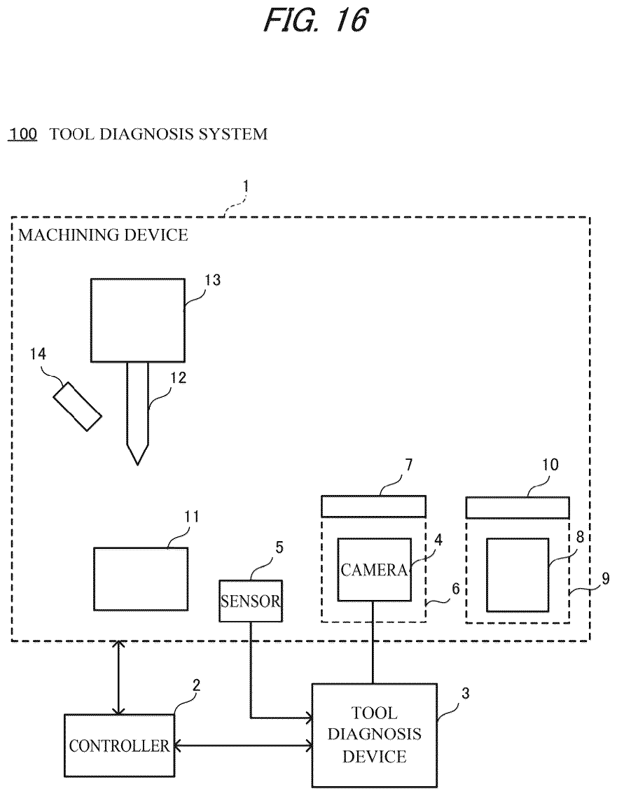

In Embodiment 4, the machining device 1 in Embodiment 2 includes the ultrasonic cleaner 8 in Embodiment 3. FIG. 16 is a block diagram of a tool diagnosis system 100 according to Embodiment 4. In the present embodiment, a machining device 1 contains the camera 4 for monitoring the blade 121 of the tool 12 and the ultrasonic cleaner 8. The camera 4 is installed in the camera protective cover 6 and the camera protective shutter 7, and is protected from the cutting fluid 125 and the chip 111. The ultrasonic cleaner 8 is installed in the ultrasonic cleaner protective cover 9 and the ultrasonic cleaner protective shutter 10, and is protected from the cutting fluid 125 and the chip 111.

After machining, the tool 12 is moved to a position directly above the ultrasonic cleaner 8, and the blade 121 of the tool 12 is immersed in a cleaning solution such as acetone or ethanol stored in the cleaning container of the ultrasonic cleaner 8 for ultrasonic cleaning. After the ultrasonic cleaning, to capture an image of the blade 121 of the tool 12, the camera 4 protected by the camera protective cover 6 and the camera protective shutter 7 moves to a position directly under the tool 12. The camera protective shutter 7 is then open to expose the camera 4. The camera 4 being exposed captures an image of the blade 121 of the tool 12.

Although the camera 4 moves in the present embodiment, the tool 12 may move to the position of the stationary camera 4. This structure allows the fool diagnosis system according to one or more embodiments of the present disclosure to be used for the machining device 1 incorporating no automatic tool changer 15. The structure also eliminates the work of transferring the tool 12 to the automatic tool changer 15, thus shortening the time for tool diagnosis. Further, the structure can remove the cutting fluid 125 and the chip 111 firmly adhering to the tool 12 and not displaced by the high-speed rotation of the tool 12 or reduce the degree of adherence of such a cutting fluid 125 and a chip 111 to the tool 12. The cutting fluid 125 and the chip 111 are displaced by the high-speed rotation of the tool 12. This allows the cutting fluid 125 and the chip 111 to be removed from the captured image more reliably than in Embodiment 1.

### Embodiment 5

In Embodiments 1 to 4, the camera is located in the rotation axis direction of the tool. In contrast, the structure according to Embodiment 5 additionally includes a camera in a direction perpendicular to the rotation axis direction of the tool. In Embodiments 1 to 4, the tool 12 is shaped to allow the flank face 123 of the blade 121 and the cutting fluid 125 and the chip 111 adhering to the flank face 123 to be observed in the rotation axis direction of the tool 12, as illustrated in FIGS. 5A and 5B. In contrast, a tool shaped to include a flank face 123 of the blade 121 that is not sufficiently visible in the rotational axial direction does not allow sufficient observation of the displacement of the cutting fluid 125 and the chip 111 adhering to the flank face 123.

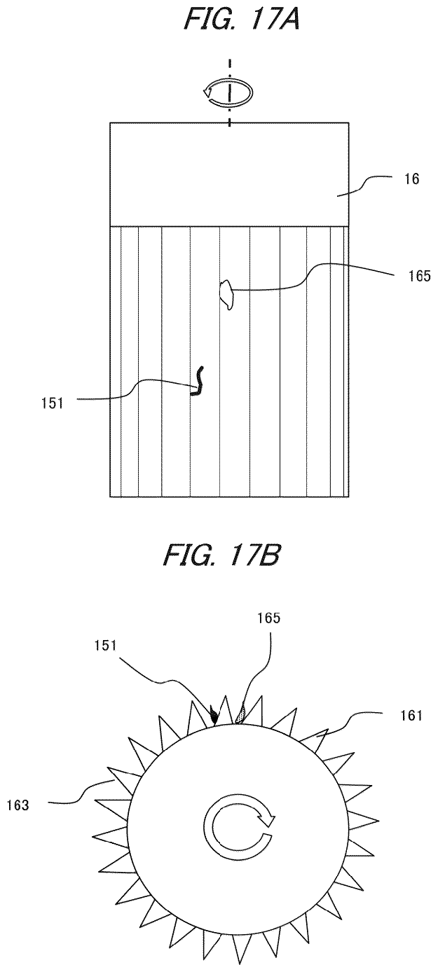

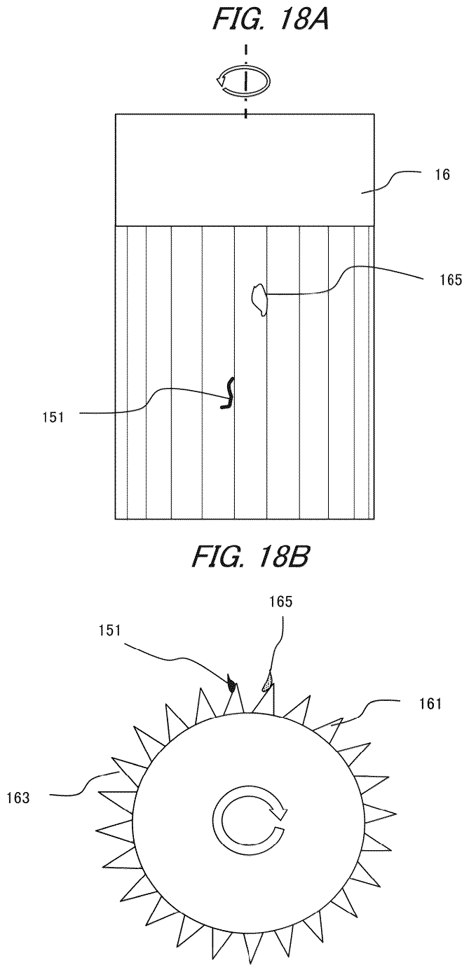

FIGS. 17A to 18B illustrate a tool 16 as an example of the tool with the above shape. FIGS. 17A and 17B are diagrams of the tool 16 after machining. FIG. 18A and 18B are diagrams of the tool 16 after high-speed rotation. FIGS. 17A and 18A illustrate the tool 16 viewed in a direction perpendicular to the rotation axis direction of the tool 16 (or illustrating the side surface). FIGS. 17B and 18B illustrate the tool 16 viewed in the rotation axis direction of the tool 16 (or illustrating the bottom surface). The arrows indicate the rotation direction of the tool 16. The tool 16 includes a blade 161 parallel to the rotation axis. A cutting fluid 165 and a chip 151 adhere to a flank face 163 of the blade 161 of the tool after machining. High-speed rotation causes the cutting fluid 165 and the chip 151 adhering to the flank face 163 to move away from the center of the rotation axis. However, the tool 16 includes the blade 161 parallel to the rotation axis. Thus, in FIG. 17B viewed in the rotation axis direction of the tool 16, the cutting fluid 165 and the chip 151 adhering to the flank face 163 cannot be observed sufficiently. The additional camera that captures an image of the tool 16 in a direction perpendicular to the rotation axis of the tool 16 allows sufficient observation of the cutting fluid 165 and the chip 151 adhering to the flank face 163. As in Embodiment 1, any patterns displaced by high-speed rotation are identified as foreign objects and are removed through image processing.

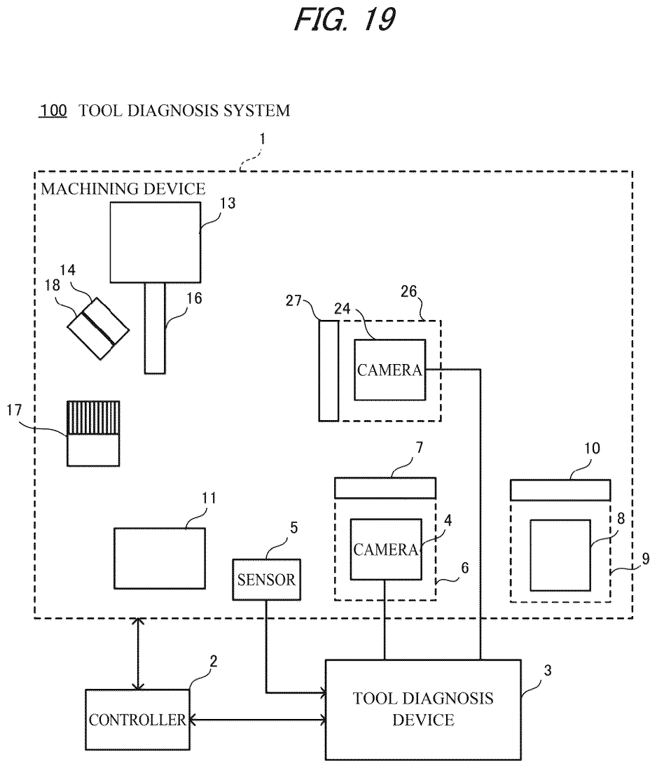

FIG. 19 is a block diagram of a tool diagnosis system 100 according to Embodiment 5 of the present disclosure. The tool diagnosis system 100 has the same structure as in FIG. 16 except that the system includes the tool 16 instead of the tool 12, a camera 24 installed in a direction perpendicular to the rotation axis direction of the tool 16, a camera protective cover 26 and a camera protective shutter 27 to protect the camera 24, and a brush 17 and an air outlet 18. Similarly to the camera 4, the camera 24 is connected to the tool diagnosis device 3 with a communication cable, The images captured by the camera 24 undergo A/D conversion before being transmitted to the tool diagnosis device 3. The tool 16 is replaceable by the tool 12. When the tool 16 is. attached, the camera 24 captures an image of the tool 16 to monitor the state of the tool 16. When the tool 12 is attached, the camera 4 captures an image of the tool 12 to monitor the state of the tool 12. This structure allows the state of the tool with any shape to be monitored sufficiently. Both the camera 4 and the camera 24 may capture images of the tool to monitor the state of the tool.

Instead of the camera 4 and the camera 24 being installed, the camera 4 may be moved as appropriate for the type of the tool to change the position and the orientation from a position and an orientation in the rotation axis direction of the tool to a position and an orientation in the direction perpendicular to the rotation axis direction of the tool, or from a position and an orientation in the direction perpendicular to the rotation axis direction of the tool to a position and an orientation in the rotation axis direction of the tool. The structure including the camera 4 moved in this manner can eliminate the additional camera 24, thus including the single camera instead of the two cameras. The camera 4 may be stationary, and the tool 12 and the tool 16 may be moved to change the positions and the orientations.

When the tool 12 and the tool 16 rotate, the brush 17 (such as a nylon brush) with lower hardness than the tool 12 and the tool 16 may be placed in contact with the blades 121 and 161 or air may be blown through the air outlet 18 onto the blades 121 and 161 to clean the blades 121 and 161 and remove the cutting fluids 125 and 165 and the chips 111 and 151. The cutting fluids 125 and 165 and the chips 111 and 151 may be removed with the ultrasonic cleaner 8 before and after the operation described above.

The structure according to Embodiment 5 allows diagnosis of the tool 16 with the blade parallel to the rotation axis, as well as the tool 12 with the blade perpendicular to the rotation axis. The blade 121 and the blade 161 in contact with the brush 17 and with air blown through the air outlet 18 are highly likely to have the cutting fluids 125 and 165 and the chips 111 and 151 removed. This allows the cutting fluids 125 and 165 and the chips 111 and 151 to be removed from the captured image more reliably than in Embodiment 1. Additional use of the ultrasonic cleaner 8 allows the cutting fluids 125 and 165 and chips 111 and 151 to be removed from the captured image more reliably than in Embodiment 4.

In the above embodiments, the data sets input into the learner 32 and the inferrer 34 are image data, machining condition data, specification data for the tool and the workpiece, and machining state data dejected by the sensor 5. However, all such data sets may not be input. For example, the machining state data may be eliminated. Other relevant data may also be additionally input.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2022-084248 filed on May 24, 2022, the entire disclosure of which is incorporated by reference herein.

### Appendix 1

A tool diagnosis system, comprising
a machining device to machine a workpiece;
an imaging device to capture an image of a blade of a tool attached to the machining device;
an image processor to process an image of the blade of the tool;
a model generator to generate a trained model through machine learning to learn a remaining service life of the tool using, as training data, a processed image of the blade of the tool, a machining condition of the machining device, and specifications of the tool and the workpiece; and
an inferrer to input a processed image of the blade of the tool, a machining condition of the machining device, and specifications of the tool and the workpiece into the trained model to output the remaining service life of the tool,
wherein the image processor compares an image of the blade of the tool captured subsequent to machining with an image of the blade of the tool captured after the tool is rotated at high speed after the image capturing subsequent to machining, and identifies a wear scar.

### Appendix 2

The tool diagnosis system according to Appendix 1, wherein
the image processor identifies, through the comparison, a pattern displaced in the images as adherent matter adhering to the blade of the tool, and removes the adherent matter from the images through image processing.

### Appendix 3

The tool diagnosis system according to Appendix 1 or 2, further comprising:
an alert generator to compare the remaining service life of the tool with a number of machining cycles and a machining distance for machining the workpiece, and when the remaining service life of the tool is shorter than a service life for the number of machining cycles and the machining distance for machining the workpiece, the alert generator generates an alert to prompt tool replacement.

### Appendix 4

The tool diagnosis system according to any one of Appendixes 1 to 3, wherein
the imaging device is located in the machining device.

### Appendix 5

The tool diagnosis system according to any one of Appendixes 1 to 4, further comprising:
an ultrasonic cleaner located in the machining device to clean the blade of the tool.

### Appendix 6

The tool diagnosis system according to any one of Appendixes 1 to 5, further comprising:
a brush or an air outlet located in the machining device to clean the blade of the tool.

### Appendix 7

A tool diagnosis device for diagnosing, from an image, a wear state of a tool in a machining device for machining a workpiece, the tool diagnosis device comprising:
an image processor to process an image of a blade of the tool;
a model generator to generate a trained model through machine learning to learn a remaining service life of the tool using, as training data, a processed image of the blade of the tool, a machining condition of the machining device, and specifications of the tool and the workpiece; and
an inferrer to input a processed image of the blade of the tool, a machining condition of the machining device, and specifications of the tool and the workpiece into the trained model to output the remaining service life of the tool,
wherein the image processor compares an image of the blade of the tool captured subsequent to machining with an image of the blade of the tool captured after the tool is rotated at high speed after the image capturing subsequent to machining, and identifies a wear scar.

### Appendix 8

A tool diagnosis method for diagnosing, from an image, a wear state of a tool in a machining device for machining a workpiece, the method comprising:
processing an image of a blade of the tool;
generating a trained model through machine learning to learn a remaining service life of the tool using, as training data, a processed image of the blade of the tool, a machining condition of the machining device, and specifications of the tool and the workpiece; and
inputting a processed image of the blade of the tool, a machining condition of the machining device, and specifications of the tool and the workpiece into the trained model to output the remaining service life of the tool,
wherein processing the image includes comparing an image of the blade of the tool captured subsequent to machining with an image of the blade of the tool captured after the tool is rotated at high speed after the image capturing subsequent to machining, and identifying a wear scar.

### Appendix 9

A program for a tool diagnosis device for diagnosing, from an image, a wear state of a tool in a machining device for machining a workpiece, the program causing a computer to function as:
an image processor to process an image of a blade of the tool;
a model generator to generate a trained model through machine learning to learn a remaining service life of the tool using, as training data, a processed image of the blade of the tool, a machining condition of the machining device, and specifications of the tool and the workpiece; and
an inferrer to input a processed image of the blade of the tool, a machining condition of the machining device, and specifications of the tool and the workpiece into the trained model to output the remaining service life of the tool,
wherein the image processor compares an image of the blade of the tool captured subsequent to machining with an image of the blade of the tool captured after the tool is rotated at high speed after the image capturing subsequent to machining, and identifies a wear sear.

### REFERENCE SIGNS LIST

1 Machining device
2 Controller
3 Tool diagnosis device
4, 24 Camera
5 Sensor
6, 26 Camera protective cover
7, 27 Camera protective shutter
8 Ultrasonic cleaner
9 Ultrasonic cleaner protective cover
10 Ultrasonic cleaner protective shutter
11 Workpiece
12, 16 Tool
13 Main spindle motor
14 Cutting fluid outlet
15 Automatic tool changer
17 Brush
18 Air outlet
31 Image processor
32 Leamer
33 Trained model storage
34 Inferrer
35 Alert generator
41 Processor
42 Main storage
43 Auxiliary storage
44 Input device
45 Output device
46 Communicator
47 Display
100 Tool diagnosis system
111,151 Chip
121, 161 Blade
122 Rake face
123, 163 Flank face
124 Wear scar
125, 165 Cutting fluid
321, 341 Data acquirer
322 Model generator
342 Remaining service life inferrer

1. A tool diagnosis system, comprising:
a machining device to machine a workpiece;
an imaging device to capture an image of a blade of a tool attached to the machining device; and
an image processor to process an image of the blade of the tool,
wherein the image processor compares an image of the blade of the tool captured subsequent to machining with an image of the blade of the tool captured after the tool is rotated after the image capturing subsequent to machining, and identifies a wear scar.

2. The tool diagnosis system according to claim 1, wherein
the image processor identifies, through the comparison, a pattern displaced in the images as adherent matter adhering to the blade of the tool, and removes the adherent matter from the images through image processing.

3. The tool diagnosis system according to claim 1, further comprising:
an alert generator to compare the remaining service life of the tool with a number of machining cycles and a machining distance for machining the workpiece, and when the remaining service life of the tool is shorter than a service life for the number of machining cycles and the machining distance for machining the workpiece, the alert generator generates an alert to prompt tool replacement.

4. The tool diagnosis system according to claim 1, wherein
the imaging device is located in the machining device.

5. The tool diagnosis system according to claim 1, further comprising:
an ultrasonic cleaner located in the machining device to clean the blade of the tool.

6. The tool diagnosis system according to claim 1, further comprising:
a brush or an air outlet located in the machining device to clean the blade of the tool.

7. A tool diagnosis device for diagnosing, from an image, a wear state of a tool in a machining device for machining a workpiece, the tool diagnosis device comprising:
an image processor to process an image of a blade of the tool,
wherein the image processor compares an image of the blade of the tool captured subsequent to machining with an image of the blade of the tool captured after the tool is rotated at high speed after the image capturing subsequent to machining, and identifies a wear scar.

8. A tool diagnosis method for diagnosing, from an image, a wear state of a tool in a machining device for machining a workpiece, the method comprising:
processing an image of a blade of the tool,
wherein processing the image includes comparing an image of the blade of the tool captured subsequent to machining with an image of the blade of the tool captured after the tool is rotated at high speed after the image capturing subsequent to machining, and identifying a wear scar.

9. (canceled)

10. The tool diagnosis system according to claim 1, further comprising:
a model generator to generate a trained model through machine learning to learn a remaining service life of the tool using, as training data, a processed image of the blade of the tool, a machining condition of the machining device, and specifications of the tool and the workpiece; and
an inferrer to input a processed image of the blade of the tool, a machining condition of the machining device, and specifications of the tool and the workpiece into the trained model to output the remaining service life of the tool.

11. The tool diagnosis device according to claim 7, further comprising:
a model generator to generate a trained model through machine learning to learn a remaining service life of the tool using, as training data, a processed image of the blade of the tool, a machining condition of the machining device, and specifications of the tool and the workpiece; and
an inferrer to input a processed image of the blade of the tool, a machining condition of the machining device, and specifications of the tool and the workpiece into the trained model to output the remaining service life of the tool.

12. The tool diagnosis method according to claim 8, further comprising:
generating a trained model through machine learning to learn a remaining service life of the tool using, as training data, a processed image of the blade of the tool, a machining condition of the machining device, and specifications of the tool and the workpiece; and
inputting a processed image of the blade of the tool, a machining condition of the machining device, and specifications of the tool and the workpiece into the trained model to output the remaining service life of the tool.

13. The tool diagnosis system according to claim 10, wherein
the image processor identifies, through the comparison, a pattern displaced in the images as adherent matter adhering to the blade of the tool, and removes the adherent matter from the images through image processing.

14. The tool diagnosis system according to claim 10, further comprising:
an alert generator to compare the remaining service life of the tool with a number of machining cycles and a machining distance for machining the workpiece, and when the remaining service life of the tool is shorter than a service life for the number of machining cycles and the machining distance for machining the workpiece, the alert generator generates an alert to prompt tool replacement.

15. The tool diagnosis system according to claim 10, wherein
the imaging device is located in the machining device.

16. The tool diagnosis system according to claim 10, further comprising:
an ultrasonic cleaner located in the machining device to clean the blade of the tool.

17. The tool diagnosis system according to claim 10, further comprising:
a brush or an air outlet located in the machining device to clean the blade of the tool.
